(19) United States
(12) Patent Application Publication
(10) Pub. No.: US 2002/0076514 A1
(43) Pub. Date: Jun. 20, 2002

(54) Polyester-based heat-shrinkable tube for covering condenser and its preparation method

(76) Inventors: Junmyoung Song, Seoul-city (KR); Youngseok Kim, Kyounggi-do (KR); Jongmin Park, Kwangju-city (KR); Gyeongjong Song, Kwangju-city (KR)

Correspondence Address: BIRCH STEWART KOLASCH & BIRCH, PO BOX 747, FALLS CHURCH, VA, 22040-0747, US

(21) Appl. No.: 09/981,922

(22) Filed: Oct. 19, 2001

(30) Foreign Application Priority Data
Oct. 24, 2000 (KR) 2000-62624

(51) Int. Cl. B32B 1/08

(52) U.S. Cl. 428/34.9; 428/36.9

(57) ABSTRACT

Disclosed is a polyester-based heat-shrinkable tube for covering a condenser that includes a polyester resin or a copolymer polyester resin as a principal component and an external particle such as talc or silica to have a slipperiness in a defined range, the polyester-based heat-shrinkable tube being applicable to a high-speed covering process on a condenser due to its good slipperiness to enhance the efficiency of working and, after covering and shrinking steps, tightly coupled to the component part of the condenser under dry heat treatment, thus securing effectiveness in protection and electrical insulation of the condenser.

### BACKGROUND OF THE INVENTION

1. Field of the Invention

The present invention relates to a polyester-based heat-shrinkable tube for covering a condenser and its preparation method and, more particularly, to a polyester-based heat-shrinkable tube for covering an electrolytic condenser for the sake of protection and electrical insulation of the electrolytic condenser, and its preparation method.

2. Description of the Related Art

In general, a heat-shrinkable tube is used to cover an electrolytic condenser in order to protect and electrically insulate the electrolytic condenser. The conventional heat-shrinkable tube has been made of a synthetic resin, polyvinyl chloride (PVC).

For example, the heat-shrinkable tube applied on an electrolytic condenser is heated at 230 to 250° C. for 2 to 3 seconds and shrunk. After being washed with water at 70 to 80° C., the heat-shrinkable tube on the electrolytic condenser is subjected to a dry heat treatment at 160° C. for 3 minutes for drying and heat resistance test. For a covering layer test, the heat-shrinkable tube is subjected to a pin hole test and a drop test.

Although widely used for covering an electrolytic condenser, the PVC-based heat-shrinkable tube is ready to tear under dry heat treatment after a pin hole test due to the low heat resistance and strength of the PVC resin, includes much defects and hardly resin is avoided in many countries because the PVC resin is non-recyclable and generates dioxin during incineration to result in serious environmental pollution. For that reason, many studies have been made on the substitute materials of the PVC resin in many countries.

In an attempt to search for a substitute resin, Japanese Laid-open Patent No. 1974-32972 discloses that a polyester-based heat-shrinkable tube applied to a condenser and shrunk can be tightly coupled to the component part of the condenser under dry heat treatment and thus very effective in protection and electrical insulation of the condenser.

When applied to the condenser and shrunk, the heat-shrinkable tube is covered on the upper and lower ends of the condenser and tightly coupled to the curved portion on the lateral side of the condenser. Such an adherence affects the deformation of the covering tube in the high temperature washing and drying steps subsequent to the covering and shrinking steps.

Recently, the slipperiness between the heat-shrinkable tube and the condenser in the covering step has become most important as the process for covering the heat-shrinkable tube on the condenser is performed in an automated manner at higher speed. A high slipperiness of the tube makes it possible to cover the tube on the condenser in a regular form without sticking to the surface of the condenser during the high-speed covering process.

### SUMMARY OF THE INVENTION

In an attempt to develop a polyester-based heat-shrinkable tube applicable to a high speed covering process on a condenser due to its high slipperiness and, after covering and shrinking steps, tightly coupled to the component part of the condenser

### SUMMARY OF THE INVENTION

In an attempt to develop a polyester-based heat-shrinkable tube applicable to a high speed covering process on a condenser due to its high slipperiness and, after covering and shrinking steps, tightly coupled to the component part of the condenser under dry heat treatment, thus securing effective protection and electrical insulation of the condenser, the inventors of the present invention found out that the addition of an external particle having an average particle diameter of 0.5 to 3.5 μm enhances the slipperiness of the tube in a defined range to satisfy the above-stated requirements of the heat-shrinkable tube, completing the present invention.

It is, therefore, an object of the present invention to provide a polyester-based heat-shrinkable tube applicable to a high-speed covering process on a condenser due to its high slipperiness and, after covering and shrinking steps, tightly coupled to the component part of the condenser under dry heat treatment, thus securing effective protection and electrical insulation of the condenser.

To achieve the above object, there is provided a polyester-based heat-shrinkable tube for covering a condenser, the heat-shrinkable tube comprising a polyester resin or a copolymer polyester resin as a principal component and 0.01 to 3 wt. % of an external particle having an average particle diameter of 0.5 to 3.5 μm, the heat-shrinkable tube having a slipperiness in the range of 300 to 800 g.

Now, the present invention will be described in detail as follows.

The thermoplastic polyester resin constituting the heat-shrinkable tube of the present invention can be polyethyleneterephthalate containing terephthalic acid as an acid component and ethylene glycol as a glycol component; copolymers containing dicarboxylic acid mixed with a high content of terephthalic acid as an acid component, the dicarboxylic acid including isophthalic acid, naphthalene dicarboxylic acid, diphenoxyethane dicarboxylic acid, diphenyl dicarboxylic acid, or diphenylether dicarboxylic acid; copolymers containing propanediol, butanediol, pentanediol, hexanediol, neopentylglycol, or polyethylene glycol, mixed with ethylene glycol as a glycol component; or mixtures of these polyesters.

The preferred polyester resin is a copolymer polyester resin containing 1 to 15 mol % of an ethylenenaphthalate component and 85 to 99 mol % of an ethyleneterephthalate component, and having an intrinsic viscosity of 0.65 to 1.0 dl/g.

Although the copolymer polyester resin can be used alone, it may be in combination with a polybutyleneterephthalate resin melted with a pigment to prepare a mixed resin composition containing 80 to 99 wt. % of the copolymer polyester resin and 1 to 20 wt. % of the pigment-containing polybutyleneterephthalate resin.

The copolymer polyester resin comprising 1 to 15 mol % of the ethylenenaphthalate component and 85 to 99 mol % of the ethyleneterephthalate component may be a mixture of the polyethyleneterephthalate resin and a polyethyleneterephthalate copolymer obtained by copolymerizing a predefined amount of dimethylester of naphthalene dicarbonic acid, the mixture containing 1 to 15 mol % of ethylenenaphthalate as a copolymer component.

Preferably, the ethylenenaphthalate copolymer component is used in an amount of 1 to 15 mol %, which guarantees an optimized crystallinity of the resulting polyethyleneterephthalate copolymer for readiness in formation of a tube.

If the content of the ethylenenaphthalate copolymer component is less than 1 mol %, the tube is difficult to form. On the contrary, if it exceeds 15 mol %, the crystallinity of the polyester-based heat-shrinkable tube significantly deteriorates to reduce the thermal stability of the tube.

The polyethyleneterephthalate copolymer containing the ethylenenaphthalate copolymer composition can be readily prepared according to a known preparation method of a polyethyleneterephthalate resin. For example, naphthalene carboxylic acid or its ester-forming derivative can be used instead of 1 to 15 mol % of the acid component in preparation of a polyester that involves the reaction of terephthalic acid or its ester-forming derivative with ethylene glycol or its ester-forming derivative.

The intrinsic viscosity of the polyethylenenaphthalate-polyethyleneterephthalate copolyester resin is preferably in the range of 0.65 to 1.0, because the molecular weight of the polyethylenenaphthalate-polyethyleneterephthalate copolyester resin is most adequate to represent good mechanical properties when the intrinsic viscosity exceeds 0.65. if the intrinsic viscosity is greater than 1.0, it is impossible to form a thin film having a thickness of less than 150 μm.

In addition, the addition of the external particle is to secure the high slipperiness of the heat-shrinkable tube of the present invention. The external particle forms projections on the surface of the tube to provide the slipperiness between the tube and the condenser. Examples of the external particle may include inorganic particles such as calcium carbonate, talc, clay, mica, aluminum silicate, silica, calcium metasilicate, or alumina trihydrate; organic particles such as teflon powder; or mixtures of them. Silica or talc is most preferred.

The addition of the external particle changes the crystallinity of the tube and hence the properties of the tube, such as adherence, dry heat resistance, or the like. So, the particle size, distribution and content of the external particle are of importance.

The size of the external particle is preferably in the range of 0.5 to 3.5 μm. If the external particle is smaller than 0.5 μm, the tube cannot have an optimized slipperiness. On the contrary, if the external particle is larger than 3.5 μm, the distribution of the external particle is decreased to deteriorate the slipperiness of the tube.

The content of the external particle is preferably in the range of 0.01 to 3 wt. % to guarantee excellence in adherence and dry heat resistance. If the content of the external particle exceeds 3 wt. %, the crystallinity of the tube is sharply reduced to have no shrinkage property and result in less adherence of the external particle to the tube.

The slipperiness is measured with a slipperiness tester, which is a push-pull scale device with an auxiliary tool.

If necessary, the polyethyleneterephthalate copolyester resin of the present invention may be mixed with an additive such as stabilizer, pigment, dye, clay, antiadditive, flame retardant, or the like to prepare a heat-shrinkable tube.

The addition of a pigment-containing polybutyleneterephthalate resin to the above-mentioned copolyester resin makes it possible to control the crystallization speed of the resin composition and secure readiness of processability. If the heat-shrinkable tube is covered on the condenser and subjected to dry heat treatment at 170° C. for 3 minutes, the formation of spaces in the component part of the condenser is avoidable. The amount of the pigment-containing polybutyleneterephthalate resin added to the above-mentioned copolyester resin is preferably in the range of 1 to 20 wt. %. If the amount is less than 1 wt. %, there is no effect on the crystallization speed of the resin composition. On the contrary, if it exceeds 20 wt. %, the crystallization speed of the resin composition is sharply increased to result in difficulty in forming an oriented tube. The content of the pigment in the polybutyleneterephthalate resin is preferably in the range of 10 to 30 wt. %.

The heat-shrinkable tube composition of the present invention may additionally contain 0.01 to 1.0 wt. % of a metal salt of benzoic acid or stearic acid in order to minutely control the crystallization speed. The addition of the metal salt of benzoic acid or stearic acid can change the crystallization speed moderately depending on the volume of the condenser to raise heat resistance.

The heat-shrinkable tube composition of the present invention may also additionally contain 1 to 5 wt. % of a polyester elastomer to increase the flexibility and adherence of the tube.

Now, a description will be given to a method for fabricating a polyester-based heat-shrinkable tube according to the present invention.

To fabricate a heat-shrinkable tube, a polyethyleneterephthalate copolyester resin containing the ethylenenaphthalate copolymer composition is melt-extruded into a tubular body by a formation method such as tube method or inflation method and then subjected to biaxial orientation. In this regard, the external particle may be added to the copolymer resin by any one of the following methods: One method involves addition of the external particle during the polymerization reaction of the copolymer resin; another method involves mixing a compounding or a polymer resin containing a predefined amount of the external particle with the copolymer resin prior to extrusion; and the other method mixes the external particle directly with the copolymer resin.

The method for fabricating a heat-shrinkable tube includes, for example, (a) extruding the copolymer composition from a tubular die to form a tubular body not oriented, (b) quenching the tubular body in a cooling bath, and (c) heating it at a temperature higher than the second-order transition temperature of the copolymer or the copolymer mixture and lower than the fluid point, while adding a compressed gas such as air and nitrogen to orient the tubular body in the transverse direction (TD) and, at the same time, drawing the tubular body in the machine direction (MD) with a differential speed roll. This biaxial orientation may be performed successively during extrusion of the tubular body or after winding the tubular body on the roll. In preparation of the non-drawn tubular body, the thickness of the heat-shrinkable tube after the biaxial orientation is preferable in the range of 50 to 100 μm. After the biaxial orientation of the tubular body not oriented, the ratio of shrinkage in the boiling water of the heat-shrinkable tube is preferably 40 to 60% in the transverse direction and 5 to 15% in the machine direction. The multiplication factors of the heat-shrinkable tube after orientation are preferably 1.7 to 2.5 in the transverse direction and 1 to 1.5 in the machine direction.

As described above, a resin composition for a polyester-based heat-shrinkable tube for covering an electrolytic condenser includes: 80 to 99 wt. % of a copolymer resin containing 1 to 15 mol % of polyethylenenaphthalate and 85 to 99 mol % of polyethyleneterephthalate, and having an intrinsic viscosity of 0.65 to 1.0 dl/g; 0.01 to 3 wt. % of an external particle, such as silica or talc, having an average particle diameter of 0.5 to 3.5 μm; and 1 to 20 wt. % of a resin containing polybutyleneterephthalate melted with a pigment. The heat-shrinkable tube is applied on a condenser (which is 24 mm long and 12.5 mm in outer diameter and has an uneven structure on the surface, the uneven structure being formed at a portion 2 to 5 mm apart from the bottom of the condenser, the deepest part of the uneven structure being 11 mm in diameter and located at a portion 4 mm above the bottom of the condenser), so that there is substantially no space formed in the component part of the condenser under dry heat treatment (170° C., 3 min.) subsequent to the covering and shrinking steps. In addition, the tube has excellent adherence to the condenser even after 3 minutes of washing with water at 100° C.

### DETAILED DESCRIPTION OF THE PREFERRED EMBODIMENTS

Hereinafter, the present invention will be described in detail by way of the following examples, which are not intended to limit the scope of the present invention.

### EXAMPLE 1

After being dried in a hot air drier at 150° C. for 6 hours, 95.4 wt. % of a polyethyleneterephthalate(PET) obtained by copolymerizing 5 mol % of dimethylester of naphthalene dicarboxylic acid and containing 0.5 wt. % of talc of which the average diameter is 2 μm; 2.5 wt. % of a polybutyleneterephthalate resin containing 30 wt. % of a pigment; 0.1 wt. % of sodium stearate; and 2 wt. % of a polyester elastomer were mixed and extruded from an extruder equipped with an annular die at a cylinder temperature of 220 to 280° C. and a die temperature of 260° C., forming a tubular body 7 mm in outer diameter and 150 μm thick. The tubular body thus obtained was cooled in a water bath at 40 ° C. and wound on a roll.

While blowing a compressed air of 0.7 kg/cm² to the end of the tubular body, the tubular body was expanded with a hot water at 90° C. and simultaneously biaxially oriented under the tensile force in the machine direction with a differential speed roll. After the biaxial orientation performed at an orientation rate of 10 m/min, the multiplication factors were 1.05 in the machine direction and 2.0 in the transverse direction.

The heat-shrinkable tube thus obtained was 13.3 mm in inner diameter and 75 μm thick and had a ratio of the transverse direction shrinkage of 48% and a ration of the mechanical direction shrinkage of 8%.

### EXAMPLES 2 TO 5 AND COMPARATIVE EXAMPLES 1 TO 5

The procedures were performed in the manners as described in Example 1, excepting the composition and the processing conditions as shown in Table 1.

TABLE 1

| | | Composition | | | | | | | Property |
|---|---|---|---|---|---|---|---|---|---|
| | | A | B | C | D | E | F | G | H |
| Examples | 1 | 95.4 | 5 | 0.5 | 2.5 | 30 | 0.1 | 2 | 0.82 |
| | 2 | 95.4 | 5 | 1.5 | 2.5 | 30 | 0.1 | 2 | 0.81 |
| | 3 | 95.4 | 5 | 2.5 | 2.5 | 30 | 0.1 | 2 | 0.79 |
| | 4 | 91.95 | 10 | 0.5 | 5 | 20 | 0.05 | 3 | 0.84 |
| | 5 | 85.9 | 5 | 0.5 | 10 | 20 | 0.1 | 4 | 0.82 |
| Comparative | 1 | 95.4 | 5 | — | 2.5 | 30 | 0.1 | 2 | 0.84 |
| Examples | 2 | 95.4 | 5 | 5 | 2.5 | 30 | 0.1 | 2 | 0.77 |
| | 3 | 97.9 | 5 | 0.5 | — | — | 0.1 | 2 | 0.69 |
| | 4 | 67.9 | 5 | 1.5 | 30 | 30 | 0.1 | 2 | 0.81 |
| | 5 | 94.0 | 5 | 0.5 | 2.5 | 30 | 1.5 | 2 | 0.82 |

Note)
A: Content of Copolymer Resin (wt. %)
B: Content of NDC (Naphthalene Dicarboxylic Acid) in Copolymer Resin (mol %)
C: Content of External Particle in Copolymer Resin (wt. %)
D: Content of Pigment-containing PBT (PolyButyleneTerephthalate) (wt. %)
E: Content of Pigment in PBT (wt. %)
F: Content of Sodium Stearate (wt. %)
G: Content of Elastomer (wt. %)
H: Intrinsic Viscosity of NDC-containing Copolymer Resin (dl/g)

### EXPERIMENTAL EXAMPLE

The heat-shrinkable tubes obtained in Examples 1 to 5 and Comparative Example 1 to 5 were evaluated in regard to the following properties.

(1) Slipperiness

The slipperiness was measured with a slipperiness tester, which is a push-pull scale device equipped with an auxiliary tool. The tubes were applicable to high-speed covering when the slipperiness was in the range of 300 to 800 g.

(2) Covering Adherence

Each heat-shrinkable tube thus obtained was applied on a 12.5 mm-diameter condenser and shrunk at 260 to 280° C. for 8 seconds under heat treatment to make the condenser tightly coupled to the tube.

O: Tightly coupled to the outer wall of the condenser, and

x: Not tightly coupled to the outer wall of the condenser, with projections formed.

(3) Hydrothermal Heat Resistance

Each heat-shrinkable tubes thus obtained was applied on a 12.5 mm-diameter condenser and shrunk at 260 to 280° C. for 8 seconds under heat treatment. The condenser tightly coupled to the tube was then subjected to hydrothermal treatment at 100±2° C. for 10 minutes.

O: Tightly coupled to the outer wall of the condenser, and

x: Not tightly coupled to the outer wall of the condenser, with projections formed.

(4) High-Temperature Heat Resistance

Each heat-shrinkable tubes thus obtained was applied on a 12.5 mm-diameter condenser and shrunk at 260 to 280° C. for 8 seconds under heat treatment. The condenser tightly coupled to the tube was then subjected to dry heat treatment at 170±5° C. for 3 minutes.

O: Tightly coupled to the outer wall of the condenser, and

x: Not tightly coupled to the outer wall of the condenser, with projections

TABLE 2

| | | | | | High- |
|---|---|---|---|---|---|
| | | | | Hydrothermal | Temperature |
| | | Slipper- | Covering | Heat | Heat |
| | | iness | Adherence | Resistance | Resistance |
| Examples | 1 | 614 | ∘ | ∘ | ∘ |
| | 2 | 477 | ∘ | ∘ | ∘ |
| | 3 | 389 | ∘ | ∘ | ∘ |
| | 4 | 683 | ∘ | ∘ | ∘ |
| | 5 | 588 | ∘ | ∘ | ∘ |
| Comparative | 1 | 1,024 | ∘ | ∘ | ∘ |
| Examples | 2 | 321 | ∘ | x | x |
| | 3 | 602 | ∘ | x | x |
| | 4 | 512 | x | x | x |
| | 5 | 564 | x | x | x |

As described above in detail, the heat-shrinkable tube, which is prepared from a composition comprising a polyethyleneterephthalate resin to which an external particle is added in order to enhance the slipperiness, a polybutyleneterephthalate resin containing a pigment, and sodium stearate or an elastomer, is applicable to a high-speed covering process on a condenser due to its good slipperiness to enhance the efficiency of working and, after covering and shrinking steps, tightly coupled to the component part of the condenser under dry heat treatment, thus securing effectiveness in protection and electrical insulation of the condenser.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A polyester-based heat-shrinkable tube for covering a condenser, the heat-shrinkable tube comprising a polyester resin or a copolyester resin as a principal component and 0.01 to 3 wt. % of an external particle having an average particle diameter of 0.5 to 3.5 μm, the heat-shrinkable tube having a slipperiness in the range of 300 to 800 g.

2. The polyester-based heat-shrinkable tube for covering a condenser as claimed in claim 1, wherein the external particle includes talc or silica.

3. The polyester-based heat-shrinkable tube for covering a condenser as claimed in claim 1, wherein the polyester resin or the copolyester resin includes a copolymer resin comprising 1 to 15 mol % of polyethylenenaphthalate and 85 to 99 mol % of polyethyleneterephthalate and having an intrinsic viscosity of 0.65 to 1.0 dl/g.

4. The polyester-based heat-shrinkable tube for covering a condenser as claimed in claim 1, wherein the polyester resin or the copolyester resin includes a mixed resin comprising: 80 to 99 wt. % of a copolymer resin comprising 1 to 15 mol % of polyethylenenaphthalate and 85 to 99 mol % of polyethyleneterephthalate and having an intrinsic viscosity of 0.65 to 1.0 dl/g; and 1 to 20 wt. % of a resin comprising polybutyleneterephthalate melted with a pigment.

5. The polyester-based heat-shrinkable tube for covering a condenser as claimed in claim 1, wherein the polyester resin or the copolyester resin includes a mixed resin comprising: 80 to 99 wt. % of a copolymer resin comprising 1 to 15 mol % of polyethylenenaphthalate and 85 to 99 mol % of polyethyleneterephthalate and having an intrinsic viscosity of 0.65 to 1.0 dl/g; 1 to 20 wt. % of a resin comprising polybutyleneterephthalate melted with a pigment; and 0.01 to 1.0 wt. % of a metal salt of benzoic acid or stearic acid.
